(19) United States
(12) Patent Application Publication
(10) Pub. No.: US 2026/0175341 A1
(43) Pub. Date: Jun. 25, 2026

(54) CHIP FILTERING SYSTEM AND CHIP FILTRATION METHOD THEREOF

(71) Applicant: INDUSTRIAL TECHNOLOGY RESEARCH INSTITUTE, Hsinchu (TW)

(72) Inventors: Szu-Chia LIN, Yilan City (TW); Shih-Jie WEI, Taichung City (TW); Shi-Jie LUO, Yuanlin City (TW)

(73) Assignee: INDUSTRIAL TECHNOLOGY RESEARCH INSTITUTE, Hsinchu (TW)

(21) Appl. No.: 19/000,855

(22) Filed: Dec. 24, 2024

(51) Int. Cl. B23Q 11/10; B01D 37/04

(52) U.S. Cl. CPC B23Q 11/1069; B01D 37/041; B01D 2221/14

(57) ABSTRACT

A chip filtering system includes a water tank, a nozzle, a filter, a nozzle pump, a filter pump, a concentration sensor and a controller. The water tank contains a cutting fluid. The nozzle is disposed in the water tank. The nozzle pump is connected to the nozzle. The filter pump is connected to the filter. The concentration sensor senses a chip concentration of the cutting fluid. The controller is configured to: when the chip concentration is equal to or greater than the preset concentration and a chip density of the cutting fluid is equal to or greater than a preset density, increase a rotation speed of the nozzle pump; and, when the chip concentration is equal to or greater than the preset concentration and the chip density of the cutting fluid chips is less than the preset density, increase a rotation speed of the filter pump.

### TECHNICAL FIELD

The disclosure relates in general to a chip filtering system and a chip filtration method thereof.

### BACKGROUND

In order to cool the workpiece machined by a machine tool, cutting fluid is generally provided to the workpiece to cool the workpiece. The cutting tool will produce chips when machining the workpiece, and the cutting fluid will carry the chips and flow back to a water tank. The chips of the cutting fluid in the water tank tend to precipitate at the bottom of the water tank, so the water tank needs to be cleaned regularly.

### SUMMARY

According to an embodiment, a chip filtering system is provided. The chip filtering system includes a water tank, a nozzle, a nozzle pump, a filter pump, a concentration sensor and a controller. The water tank is configured to contain a cutting fluid. The nozzle is disposed in the water tank. The nozzle pump is connected to the nozzle. The filter pump is connected to the filter. The concentration sensor is configured to sense a chip concentration of the cutting fluid. The controller electrically is connected to the nozzle pump, the filter pump and the concentration sensor and configured to: determine whether the chip concentration is equal to or greater than a preset concentration; when the chip concentration is equal to or greater than the preset concentration and a chip density of a chip in the cutting fluid is equal to or greater than a preset density, increase a rotational speed of the nozzle pump; and when the chip concentration is equal to or greater than the preset concentration and the chip density of the chip is less than the preset density, increase a rotation speed of the filter pump.

According to another embodiment, a chip filtering method is provided. The chip filtering method includes the following steps: determine whether a chip concentration of a cutting fluid in a water tank of a chip filtering system is equal to or greater than a preset concentration; when the chip concentration is equal to or greater than the preset concentration and a chip density of a chip in the cutting fluid is equal to or greater than a preset density, increase a rotation speed of a nozzle pump; and when the chip concentration is equal to or greater than the preset concentration and the chip density of the chip is less than the preset density, increase a rotation speed of a filter pump.

The above and other aspects of the disclosure will become better understood with regard to the following detailed description of the preferred but non-limiting embodiment (s). The following description is made with reference to the accompanying drawings.

### BRIEF DESCRIPTION OF THE DRAWINGS

FIG. 1 illustrates a functional block diagram of a chip filtering system according to an embodiment of the present invention;

FIG. 2 illustrates an equipment schematic diagram of the chip filtering system in FIG. 1;

FIG. 3 illustrates a flow chart of a chip filtering method of the chip filter system in FIG. 1; and

FIGS. 4A and 4B illustrate simulation diagrams of the flow field of the water tank.

### DETAILED DESCRIPTION

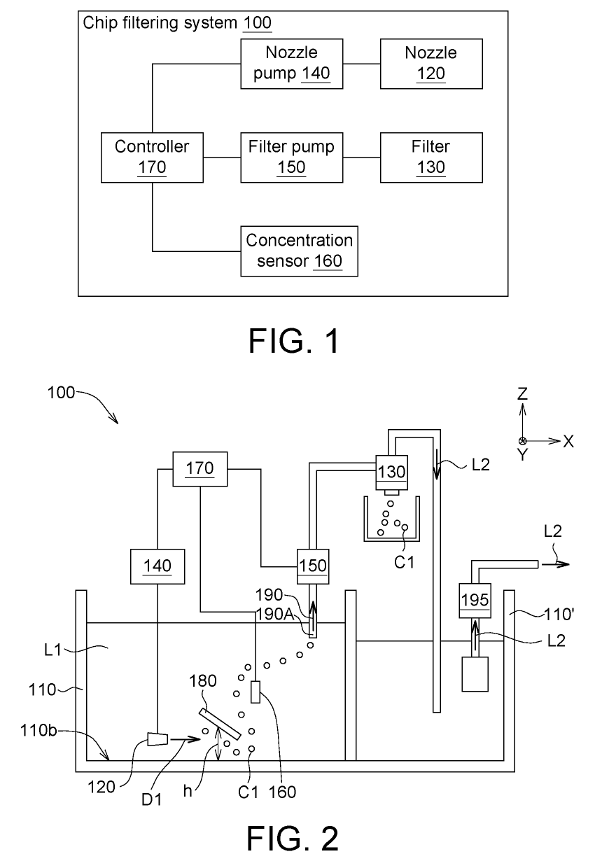

Referring to FIGS. 1 to 2, FIG. 1 illustrates a functional block diagram of a chip filtering system 100 according to an embodiment of the present invention, and FIG. 2 illustrates an equipment schematic diagram of the chip filtering system 100 in FIG. 1.

As illustrated in FIGS. 1 and 2, the chip filtering system 100 includes a water tank 110, at least one nozzle 120, a filter 130, a nozzle pump 140, a filter pump 150, a concentration sensor 160, a controller 170, at least one spoiler 180 and a liquid suction pipe 190.

As illustrated in FIGS. 1 and 2, the water tank 110 is configured to contain the cutting fluid L1. The nozzle 120 is disposed in the water tank 110. The nozzle pump 140 is connected to the nozzle 120. The filter pump 150 is connected to the filter 130. The concentration sensor 160 is configured to sense the chip concentration of the cutting fluid L1. The controller 170 is electrically connected to the nozzle pump 140, the filter pump 150 and the concentration sensor 160 and configured to: determine whether the chip concentration is greater than a preset concentration; when the chip concentration is equal to or greater than a preset concentration and a chip density of the chip C1 in the cutting fluid L1 is equal to or greater than a preset density, increase a rotation speed of the nozzle pump 140; and when the chip concentration is equal to or greater than the preset concentration and the chip density of the chips C1 in the cutting fluid L1 is not greater than the preset density, increase a rotation speed of the filter pump 150. As a result, through the rotation speed control of the nozzle pump 140 and the filter pump 150, the chips C1 may be moderately disturbed, and thus it may improve the problem of sedimentation of the chips C1 and reduce the frequency of cleaning the water tank 110.

The cutting fluid L1 in the water tank 110 is, for example, the coolant for cooling the workpiece (not illustrated) processed by the machine tool (not illustrated), and it contains many chips C1. Through the chip filtering system 100 of the embodiment of the present disclosure, the chips C1 may be filtered out. The chips C1 are made of, for example, aluminum, steel, iron, titanium, etc. However, the chip C1 depends on the material of the workpiece processed by the machine tool, and it is not limited in the embodiment of the present disclosure.

As illustrated in FIG. 2, the nozzle 120 may be disposed on any position of the water tank 110, as long as it may disturb the chips C1 and improve the problem of the precipitation of the chips C1. In addition, the number of nozzles 120 may be one or more, and it is not limited in the embodiment of the present disclosure. In an embodiment, a flow field length between the two nozzles 120 may range between 400 mm (millimeter) and 600 mm, or a nozzle 120 may be disposed on a turning point of the flow field so that there is no chip precipitation in the flow field length between the two nozzles 120. In addition, the nozzles 120 may be disposed in pairs, that is, two nozzles 120 may be adjacently disposed to form a nozzle group which may be disposed together at a position of the water tank 110. In addition, an angle between an injection direction D1 of the nozzle 120 and a horizontal axis X is at least 0 degree, and thus a spray distance of the nozzle may be maximized to prevent the chips C1 from being precipitate in the water tank, thereby increasing the flow field mixing effect and reducing the dead spot in the water tank 110 where the chips C1 are precipitated.

As illustrated in FIG. 2, the nozzle pump 140 may control the nozzle 120 to eject an air flow to disturb the chips C1 in the cutting fluid L1. In an embodiment, the nozzle pump 140 is, for example, a variable frequency pump. Through frequency modulation control, the rotation speed of the nozzle pump 140 may be changed. The nozzle pump 140 may also be a volumetric pump, a dynamic pump, an electromagnetic pump, a vacuum pump, a centrifugal pump, etc., and the embodiments of the present invention are not limited to this. As long as the pump is capable of preventing the chips from being precipitated in the water tank, increasing the flow field mixing effect and reducing the occurrence of dead spot, such pump can be applied to the present embodiment.

As illustrated in FIG. 2, the filter pump 150 may draw the cutting fluid L1 in the water tank 110 and transport the cutting fluid L1 to the filter 130. The filter pump 150 is, for example, a variable frequency pump. Through frequency modulation control, the rotation speed of the filter pump 150 may be changed. The filter 130 may filter out the chips C1 in the cutting fluid L1 and discharge the chips C1 out of the filter 130. The filtered cutting fluid L2 may be transported to another water tank 110' of the chip filtering system 100 for recycling. The chip filtering system 100 further includes a pump 195. The pump 195 may draw the cutting fluid L2 in the water tank 110' and provide the cutting fluid L2 to the machine tool (not illustrated) to cool the workpiece (not illustrated) processed by the machine tool. In addition, the controller 170 is electrically connected to the pump 195 to control the operation of the pump 195.

As illustrated in FIG. 2, the concentration sensor 160 is disposed in the water tank 110 and is configured to sense the chip concentration of the cutting fluid L1. The concentration sensor 160 may detect a turbidity of the cutting fluid L1 to determine the chip concentration of the cutting fluid L1. The higher the turbidity of the cutting fluid L1 is, the higher the chip concentration is; the lower the turbidity of the cutting fluid L1 is, the lower the chip concentration is. Furthermore, the concentration sensor 160 is, for example, a turbidity sensor, a conductivity sensor, a total dissolved solid (TDS) sensor, or the like. The concentration sensor 160 is mainly configured to sense the chip concentration, so any sensor with such function may be used as the concentration sensor 160 in this application.

As illustrated in FIG. 2, the controller 170 is, for example, a semiconductor chip or a semiconductor package formed by using at least one semiconductor process. The controller 170 is further configured to: when the chip concentration of the cutting fluid L1 is less than the preset concentration and the chip density of the chips C1 of the cutting fluid L1 is less than the preset density, control the nozzle pump 140 to maintain the current rotation speed and control the filter pump 150 to stop operating. Furthermore, when the chip concentration is less than the preset concentration and the chip density of the chips C1 of the cutting fluid L1 is less than the preset density, the nozzle pump 140 continues to control the nozzle 120 to disturb the chips C1, but the filter pump 150 may stop operating (compared with the chips C1 with a higher chip density, the chips C1 with a smaller chip density are not easy to precipitate) to save the overall power consumption of the system. When the chip concentration of the cutting fluid L1 is equal to or greater than the preset concentration (the chips C1 in the cutting fluid L1 accumulate to a certain extent), the filter pump 150 is again controlled to start operating.

In an embodiment, the aforementioned chip concentration may range between, for example, 3% and 7%, for example, 5%, but it may also be greater or less. The aforementioned preset density may range between, for example, 1.5 grams per cubic centimeter (g/cm³) and 4.5 g/cm³, such as 3 g/cm³.

As illustrated in FIG. 2, the spoiler 180 may be disposed in the water tank 110. There is a distance h between the spoiler 180 and the bottom surface 110b of the water tank 110, and the distance h gradually reduces in a direction away from the nozzle 120. As a result, the flow speed of the airflow from the nozzle 120 gradually increases when the airflow travels through space between the spoiler 180 and the bottom surface 110b of the water tank 110, thereby improving the turbulence effect. In an embodiment, the number of spoilers 180 may be multiple (only one is illustrated in FIG. 2), and the flow field length between two spoilers 180 may range between 200 mm and 300 mm, so that there is no chip precipitation in the flow field length between the two spoilers 180.

As illustrated in FIG. 2, the liquid suction pipe 190 is connected to the filter pump 150. The liquid suction pipe 190 has a liquid suction end 190A. The liquid suction end 190A enters the water tank 110 to draw the cutting fluid l1 in the water tank 110.

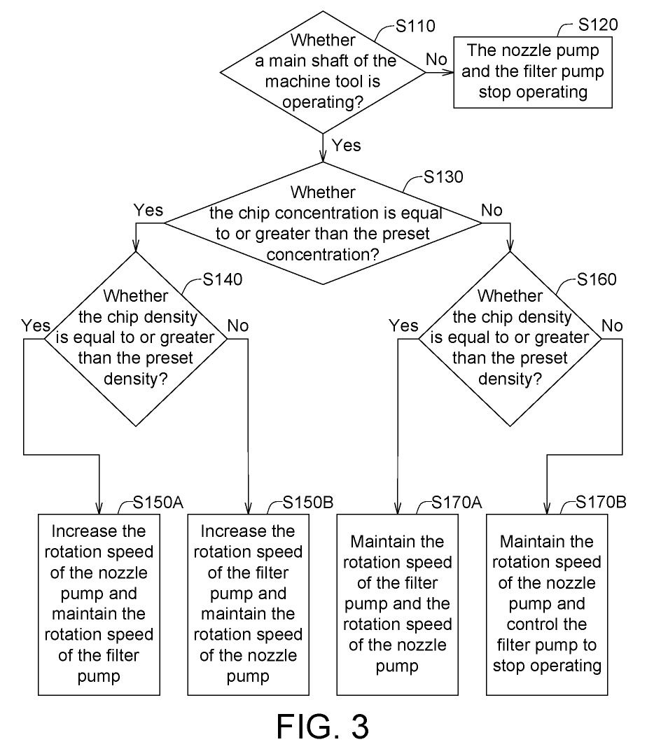

Referring to FIG. 3, FIG. 3 illustrates a flow chart of a chip filtering method of the chip filter system 100 in FIG. 1.

In step S110, the controller 170 determines whether a main shaft of the machine tool is operating. If yes, it means that the machine tool is processing the workpiece, so the chips C1 will be generated. The cutting fluid L2 cools the workpiece processed by the machine tool, carries the chips C1, and flows into the water tank 110. When the main shaft of the machine tool is not operating, the process proceeds to step S120; when the main shaft of the machine tool is operating, the process proceeds to step S130.

In step S120, the controller 170 controls the nozzle pump 140 and the filter pump 150 to stop operating.

In step S130, the controller 170 determines whether the chip concentration of the cutting fluid L1 is equal to or greater than the preset concentration. When the chip concentration is equal to or greater than the preset concentration, the process proceeds to step S140. When the chip concentration is less than the preset concentration, the process proceeds to step S160.

In step S140, the controller 170 determines whether the chip density of the chips C1 is equal to or greater than the preset density. When the chip density of the chips C1 is equal to or greater than the preset density (the chips C1 are heavier and easy to precipitate), the process proceeds to step S150A. When the chip density is less than the preset density (the chips C1 are lighter and if the rotation speed of the filter 130 is insufficient, the centrifugal force is less and thus it is difficult to be filtered out), the process proceeds to step S150B.

In step S150A, the controller 170 increases the rotation speed of the nozzle pump 140 to disturb the chips C1 in the water tank 110 for avoiding the precipitation of the chips C1, and maintains the current rotation speed of the filter pump 150 (which may save energy consumption).

In step S150B, the controller 170 increases the rotation speed of the filter pump 150 to increase the centrifugal force for the chips C1 entering the filter 130 for increasing the filtration efficiency for the chips C1, and maintains the current rotation speed of the nozzle pump 140 (which may save energy consumption).

In step S160, the controller 170 determines whether the chip density of the chips C1 is equal to or greater than the preset density. When the chip density of the chips C1 is equal to or greater than the preset density (the chips C1 is heavier), the process proceeds to step S170A. When the chip density is less than the preset density (chips C1 is lighter), the process proceeds to step S170B.

In step S170A, since the chip concentration is less than the preset concentration, the controller 170 maintains the rotation speed of the filter pump 150 and the rotation speed of the nozzle pump 140.

In step S170B, although the chip concentration is less than the preset concentration, based on the chips C1 being less than the preset density (the chips C1 are lighter and not easy to settle), the controller 170 controls the filter pump 150 to stop operating but still maintain the rotation speed of the nozzle pump 140 to continue to disturb the chips C1.

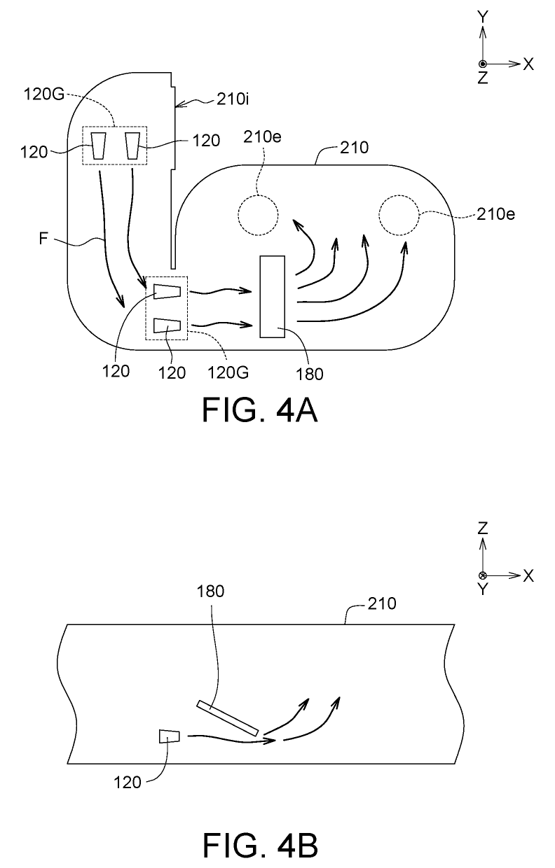

Referring to FIGS. 4A and 4B, FIGS. 4A and 4B illustrate simulation diagrams of the flow field of the water tank 210. Two nozzle groups 120G (one nozzle group 120G includes two nozzles 120) and one spoiler 180 are disposed in the water tank 210. The flow field length between the two nozzle groups 120G ranges between, for example, 400 mm and 600 mm. The water tank 210 has a flow field F, a flow field inlet 210i and at least one first flow field outlet 210e. The cutting fluid L1 enters the water tank 210 through the flow field inlet 210i, and leaves the water tank 210 through the flow field outlet 210e. According to the flow field simulation diagram, due to the configuration of the two nozzle groups 120G and the spoiler 180, the flow field between the two nozzle groups 120G is continuous, the flow field between the nozzle group 120G and the spoiler 180 is continuous, and it proves that the chips C1 in the water tank 210 may continue to be disturbed by the flow field, thereby reducing the amount of sedimentation, or even avoids occurrence of sedimentation. In addition, it may also be proved, through simulation, that when the flow field length between the two nozzle groups 120G is between 400 mm and 600 mm and or a nozzle 120 may be disposed at a turning point of the flow field, there is no chip precipitation in the flow field length between the two nozzles 120. It may also be proved, through simulation, that when the flow field length between the two spoilers 180 may range between 200 mm and 300 mm, there is no chip precipitation in the flow field length between the two spoilers 180.

In summary, the chip filtering system and the chip filtration method thereof according to embodiments of the present invention may control the rotation speed of the nozzle pump and/or the rotation speed of the filter pump according to the chip concentration of the cutting fluid and/or the chip density of the chips for moderately disturbing the chips in the water tank to reduce or even prevent the precipitation of cutting fluid in the water tank, thereby reducing the frequency of cleaning the water tank.

It will be apparent to those skilled in the art that various modifications and variations could be made to the disclosed embodiments. It is intended that the specification and examples be considered as exemplary only, with a true scope of the disclosure being indicated by the following claims and their equivalents.

What is claimed is:

1. A chip filtering system, comprising:
a water tank configured to contain a cutting fluid;
a nozzle disposed in the water tank;
a filter;
a nozzle pump connected to the nozzle;
a filter pump connected to the filter;
a concentration sensor configured to sense a chip concentration of the cutting fluid;
a controller electrically connected to the nozzle pump, the filter pump and the concentration sensor and configured to:
determine whether the chip concentration is equal to or greater than a preset concentration;
when the chip concentration is equal to or greater than the preset concentration and a chip density of a chip in the cutting fluid is equal to or greater than a preset density, increase a rotational speed of the nozzle pump; and
when the chip concentration is equal to or greater than the preset concentration and the chip density of the chip is less than the preset density, increase a rotation speed of the filter pump.

2. The chip filtering system according to claim 1, wherein the controller is further configured to:
when the chip concentration is less than the preset concentration and the chip density of the chip is less than the preset density, control the filter pump to stop operating.

3. The chip filtering system according to claim 1, wherein the chip concentration is 5%.

4. The chip filtering system according to claim 1, wherein the preset density is 3 g/cm3.

5. The chip filtering system according to claim 1, wherein an angle between an injection direction of the nozzle and a horizontal axis is at least 0 degree.

6. The chip filtering system according to claim 1, further comprising:
a spoiler disposed in the water tank;
wherein there is a distance between the spoiler and a bottom surface of the water tank, and the distance gradually reduces in a direction away from the nozzle.

7. The chip filtering system according to claim 5, further comprising:
a plurality of spoilers;
wherein a flow field length between two adjacent spoilers ranges between 200 mm and 300 mm.

8. The chip filtering system according to claim 1, further comprising:
a plurality of nozzles;
wherein a flow field length between two adjacent nozzles ranges between 400 mm and 600 mm.

9. The chip filtering system according to claim 1, further comprising:
a liquid suction pipe connected to the filter pump and having a liquid suction end, wherein the liquid suction end is located within the water tank.

10. A chip filtering method, comprising:
determine whether a chip concentration of a cutting fluid in a water tank of a chip filtering system is equal to or greater than a preset concentration;
when the chip concentration is equal to or greater than the preset concentration and a chip density of a chip in the cutting fluid is equal to or greater than a preset density, increase a rotation speed of a nozzle pump; and
when the chip concentration is equal to or greater than the preset concentration and the chip density of the chip is less than the preset density, increase a rotation speed of a filter pump.

11. The chip filtering method according to claim 10, further comprising:
when the chip concentration is less than the preset concentration and the chip density of the chip is less than the preset density, controlling the filter pump to stop operating.

12. The chip filtering method according to claim 10, wherein the chip concentration is 5%.

13. The chip filtering method according to claim 10, wherein the preset density is 3 g/cm3.

14. The chip filtering method according to claim 10, wherein an angle between an injection direction of the nozzle and a horizontal axis is at least 0 degree.

15. The chip filtration method according to claim 10, wherein the chip filtering system further comprises a spoiler disposed in the water tank, there is a distance between the spoiler and a bottom surface of the water tank, and the distance gradually reduces in a direction away from the nozzle.

16. The chip filtration method according to claim 15, wherein the chip filtering system includes a plurality of the spoilers, and a flow field length between two adjacent spoilers ranges between 200 mm and 300 mm.

17. The chip filtration method according to claim 10, wherein the chip filtering system includes a plurality of nozzles disposed in the water tank, and a flow field length between two adjacent nozzles ranges between 400 mm and 600 mm.

18. The chip filtration method according to claim 9, wherein the chip filtering system further comprises a liquid suction pipe, the liquid suction pipe is connected to the filter pump and has a liquid suction end, and the liquid suction end is located within the water tank.
